(19) United States
(12) Patent Application Publication
(10) Pub. No.: US 2024/0404294 A1
(43) Pub. Date: Dec. 5, 2024

(54) IMAGE PROCESSING APPARATUS, MOBILE OBJECT, AND PROGRAM

(71) Applicant: KYOCERA Corporation, Kyoto (JP)

(72) Inventor: Akihiro NOMOTO, Ashigarashimo-gun, Kanagawa (JP)

(73) Assignee: KYOCERA Corporation, Kyoto (JP)

(21) Appl. No.: 18/695,619

(22) PCT Filed: Sep. 27, 2022
(86) PCT No.: PCT/JP2022/036027

§ 371 Date: Mar. 26, 2024

(30) Foreign Application Priority Data
Sep. 28, 2021 (JP) 2021-158400

(51) Int. Cl. G06V 20/56

(52) U.S. Cl. CPC G06V 20/56

(57) ABSTRACT

An image processing apparatus, a mobile object, and a program are provided that are able to generate an image of surroundings of a mobile object without increasing a processing load. An image processing apparatus (10) includes an input unit (101) and a controller (102). The input unit (101) is configured to acquire a first image and a second image. The first image is captured by a first image capture device (11) configured to shoot in a first direction toward rear on a right-hand side relative to a direction of travel of the mobile object. The second image is captured by a second image capture device (12). The second image capture device (12) is disposed away from the first image capture device (11) in the direction of travel and in a left or right direction and is configured to shoot in a second direction toward the rear on the right-hand side. The controller (102) is configured to perform a first control to generate the image of the surroundings of the mobile object based on the first image and the second image.

### CROSS-REFERENCE TO RELATED APPLICATIONS

This application claims priority from Japanese Patent Application No. 2021-158400 (filed Sep. 28, 2021), the content of which is all incorporated herein by reference.

### TECHNICAL FIELD

The present disclosure relates to an image processing apparatus, a mobile object, and a program.

### BACKGROUND OF INVENTION

An apparatus has been disclosed that is configured to combine images of a scene behind a vehicle to generate a single image with a wide field of view. The images are individually captured by three cameras disposed one each at a center rear position, on the left-hand side, and on the right-hand side of the vehicle (refer to, for example, Patent Literature 1).

### CITATION LIST

### Patent Literature

Patent Literature 1: Japanese Unexamined Patent Application Publication No. 2003-255925

### SUMMARY

### Solution to Problem

In an embodiment of the present disclosure, an image processing apparatus includes an input unit and a controller. The input unit is configured to acquire a first image and a second image. The first image is captured by a first image capture device configured to shoot in a first direction toward rear on a right-hand side relative to a direction of travel of a mobile object. The second image is captured by a second image capture device. The second image capture device is disposed away from the first image capture device in the direction of travel and in a left or right direction and is configured to shoot in a second direction toward the rear on the right-hand side. The controller is configured to perform a first control to generate an image of surroundings of the mobile object based on the first image and the second image.

In an embodiment of the present disclosure, a mobile object includes an image processing apparatus including an input unit and a controller. The input unit is configured to acquire a first image and a second image. The first image is captured by a first image capture device configured to shoot in a first direction toward rear on a right-hand side relative to a direction of travel of the mobile object. The second image is captured by a second image capture device. The second image capture device is disposed away from the first image capture device in the direction of travel and in a left or right direction and is configured to shoot in a second direction toward the rear on the right-hand side. The controller is configured to perform a first control to generate an image of surroundings of the mobile object based on the first image and the second image.

In an embodiment of the present disclosure, a program is configured to cause a controller in an image processing apparatus to perform a first control to generate an image of surroundings of a mobile object based on a first image and a second image. The image processing apparatus includes an input unit and the controller. The input unit is configured to acquire the first image and the second image. The first image is captured by a first image capture device configured to shoot in a first direction toward rear on a right-hand side relative to a direction of travel of the mobile object. The second image is captured by a second image capture device. The second image capture device is disposed away from the first image capture device in the direction of travel and in a left or right direction and is configured to shoot in a second direction toward the rear on the right-hand side.

In an embodiment of the present disclosure, an image processing apparatus includes an input unit and a controller. The input unit is configured to acquire a first image and a second image. The first image is captured by a first image capture device configured to shoot in a first direction toward rear on a left-hand side relative to a direction of travel of a mobile object. The second image is captured by a second image capture device. The second image capture device is disposed away from the first image capture device in the direction of travel and in a left or right direction and is configured to shoot in a second direction toward the rear on the left-hand side. The controller is configured to perform a first control to generate an image of surroundings of the mobile object based on the first image and the second image.

In an embodiment of the present disclosure, a mobile object includes an image processing apparatus including an input unit and a controller. The input unit is configured to acquire a first image and a second image. The first image is captured by a first image capture device configured to shoot in a first direction toward rear on a left-hand side relative to a direction of travel of the mobile object. The second image is captured by a second image capture device. The second image capture device is disposed away from the first image capture device in the direction of travel and in a left or right direction and is configured to shoot in a second direction toward the rear on the left-hand side. The controller is configured to perform a first control to generate an image of surroundings of the mobile object based on the first image and the second image.

In an embodiment of the present disclosure, a program is configured to cause a controller in an image processing apparatus to perform a first control to generate an image of surroundings of a mobile object based on a first image and a second image. The image processing apparatus includes an input unit and the controller. The input unit is configured to acquire the first image and the second image. The first image is captured by a first image capture device configured to shoot in a first direction toward rear on a left-hand side relative to a direction of travel of the mobile object. The second image is captured by a second image capture device. The second image capture device is disposed away from the first image capture device in the direction of travel and in a left or right direction and is configured to shoot in a second direction toward the rear on the left-hand side.

### BRIEF DESCRIPTION OF THE DRAWINGS

FIG. 1 is a block diagram depicting a schematic configuration of an image capture system including an image processing apparatus according to an embodiment of the present disclosure.

FIG. 2 depicts an example of an arrangement of image capture devices in the image capture system in FIG. 1 and a field of view and a shooting direction of each image capture device.

FIG. 3 depicts an example of a configuration of a display device.

FIG. 4 describes generation of an image of the surroundings of a mobile object in accordance with a first control.

FIG. 5 describes generation of an image of the surroundings of the mobile object in accordance with a second control.

FIG. 6 describes generation of an image of the surroundings of the mobile object in accordance with a third control.

FIG. 7 is a flowchart illustrating a process performed by a controller in the image processing apparatus according to the embodiment of the present disclosure.

FIG. 8 describes generation of a composite image according to a known technology.

### DESCRIPTION OF EMBODIMENTS

An image processing apparatus, a mobile object, and a program will be described herein with reference to the drawings according to an embodiment of the present disclosure. Figures used in the following description are schematically drawn. The dimensions, proportions, and the like in the figures do not necessarily represent the actual ones. (Configuration of Image Capture System)

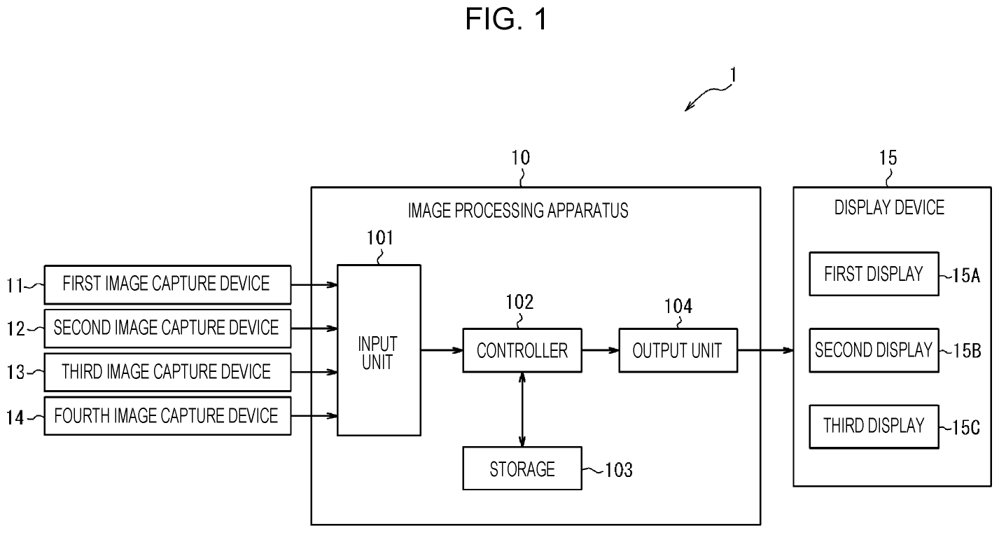

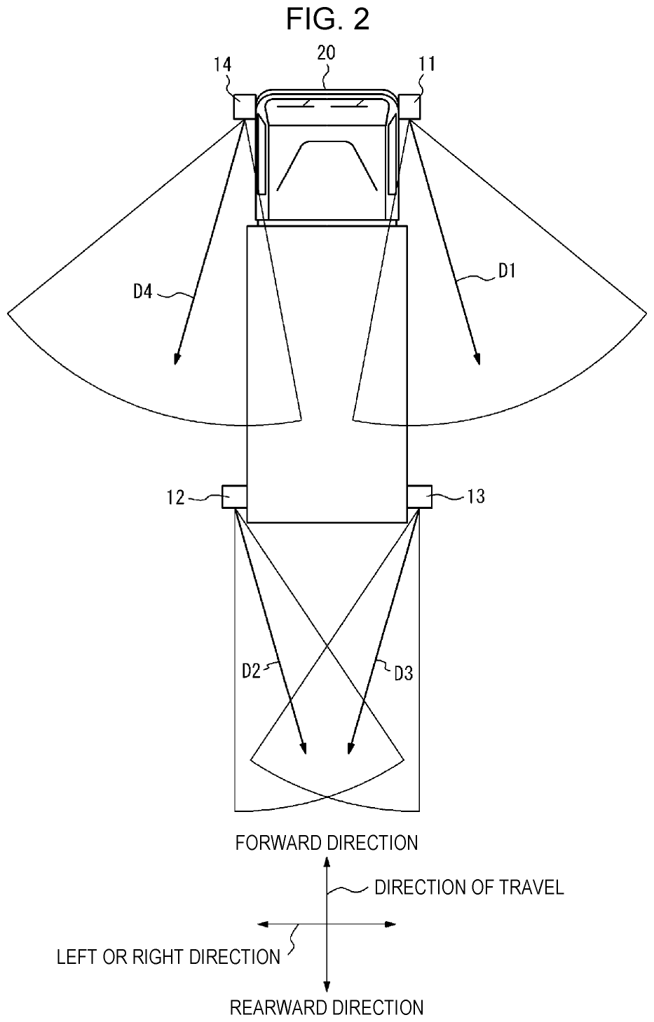

FIG. 1 is a block diagram depicting a schematic configuration of an image capture system 1 including an image processing apparatus 10 according to the present embodiment. The image capture system 1 includes a first image capture device 11, a second image capture device 12, a third image capture device 13, a fourth image capture device 14, the image processing apparatus 10, and a display device 15. The image processing apparatus 10 is configured to output to the display device 15 an image acquired by combining at least part of images that are output from the first image capture device 11, the second image capture device 12, the third image capture device 13, and the fourth image capture device 14. The image capture system 1 is a vehicle-mounted system to be mounted on a mobile object 20 (refer to FIG. 2) including, for example, a truck and a passenger car. As a specific example, the image capture system 1 may be an electronic mirror system in which side view mirrors are replaced with cameras and display screens. In the following description, the image capture system 1 is assumed to be an electronic mirror system mounted on the mobile object 20, which is a truck.

The first image capture device 11, the second image capture device 12, the third image capture device 13, and the fourth image capture device 14 are each a camera including one or more lenses and image capture elements. Examples of the image capture element include, but are not limited to, a CCD image sensor (charge-coupled device image sensor) and a CMOS image sensor (complementary MOS image sensor). The first image capture device 11, the second image capture device 12, the third image capture device 13, and the fourth image capture device 14 are each configured to convert into an electric signal an image formed through a lens on the light receiving surface of the image capture element. The first image capture device 11, the second image capture device 12, the third image capture device 13, and the fourth image capture device 14 may each apply any image processing to an image converted into an electric signal (image data), and examples of such image processing include brightness adjustment, contrast adjustment, and gamma correction. (Image Capture Device)

The first image capture device 11, the second image capture device 12, the third image capture device 13, and the fourth image capture device 14 are disposed at different positions. FIG. 2 depicts an example of an arrangement of cameras in the image capture system 1 and a field of view and a shooting direction of each camera. As depicted in FIG. 2, a forward direction in which the mobile object 20 travels in a normal run and a rearward direction opposite to the forward direction are collectively referred to as the direction of travel. A direction perpendicular to the direction of travel is referred to as a left or right direction or a sideways direction.

In the present embodiment, the first image capture device 11 is disposed on the right side of the mobile object 20 and close to the front edge of the mobile object 20. In other words, the first image capture device 11 is disposed at a front right position of the mobile object 20 relative to the direction of travel of the mobile object 20, and more specifically, at or close to a position of the side view mirror on the driver's seat side of an ordinary truck. The positions of the second image capture device 12, the third image capture device 13, and the fourth image capture device 14 are determined relative to the position of the first image capture device 11.

The second image capture device 12 is disposed away from the first image capture device 11 in the direction of travel and in the left or right direction. In the present embodiment, the second image capture device 12 is disposed close to the rear end of the mobile object 20 and on the other side from the first image capture device 11 in the left or right direction. In other words, the second image capture device 12 is disposed on the left side in the rear of the truck bed.

The third image capture device 13 is disposed away from the first image capture device 11 in the direction of travel. In the present embodiment, the third image capture device 13 is disposed close to the rear end of the mobile object 20 and on the same side as the first image capture device 11 in the left or right direction. In other words, the third image capture device 13 is disposed on the right side in the rear of the truck bed.

The fourth image capture device 14 is disposed away from the first image capture device 11 in the left or right direction. In the present embodiment, the fourth image capture device 14 is disposed close to the front end of the mobile object 20 and on the other side from the first image capture device 11 in the left or right direction. In other words, the fourth image capture device 14 is disposed at a front left position of the mobile object 20 relative to the direction of travel of the mobile object 20, and more specifically, at or close to a position of the side view mirror on the other side from the driver's seat of the truck.

The first image capture device 11 is configured to shoot in a first direction D1. The first direction D1 is the direction in which the optical axis of the first image capture device 11 is oriented. In the present embodiment, the first direction D1 is oriented toward the rear and sideways relative to the direction of travel of the mobile object 20. A direction toward the rear and sideways may be a direction toward the rear on the right-hand side or a direction toward the rear on the left-hand side. A direction toward the rear on the right-hand side is oriented toward the rear and sideways on the right-hand side. A direction toward the rear on the left-hand side is oriented toward the rear and sideways on the left-hand side. In the following description of the embodiment, the first direction D1 is assumed to be oriented toward the rear on the right-hand side. The first image capture device 11 is configured to capture a first image by shooting in the first direction D1 and output image data of the first image to an input unit 101.

The second image capture device 12 is configured to shoot in a second direction D2. The second image capture device 12 is configured to capture a second image by shooting in the second direction D2 and output image data of the second image to the input unit 101. Since the second image capture device 12 is configured to shoot in the second direction D2, the image of an object located at a blind spot for the first image capture device 11 and the fourth image capture device 14 behind the mobile object 20 can be captured. The second direction D2 is the direction in which the optical axis of the second image capture device 12 is oriented. The first direction D1 may coincide with the second direction D2. The first direction D1 and the second direction D2 may differ by a small amount. The small amount may be, for example, less than 10°. If the two directions differ by less than 10°, the surroundings of the mobile object 20 can be displayed with a wide angle of view within constraints on parameters such as the angles of view of the cameras and spaces to be occupied by the cameras installed onto the mobile object 20. If the two directions differ by less than 10°, a blind spot to be generated in a gap between images to be combined can be reduced. In the following description of the embodiment, the second direction D2 is assumed to be oriented toward the rear on the right-hand side in the same manner as, and/or similarly to, the first direction D1.

The fourth image capture device 14 is configured to shoot in a fourth direction D4. The fourth direction D4 is the direction in which the optical axis of the fourth image capture device 14 is oriented. In the present embodiment, the fourth direction D4 is oriented toward the rear and sideways relative to the direction of travel of the mobile object 20 and is opposite to the first direction D1 in the left or right direction. In the following description of the embodiment, the fourth direction D4 is assumed to be oriented toward the rear on the left-hand side. The fourth direction D4 may be symmetrical with the first direction D1 in the left or right direction but is not limited to this arrangement. The fourth image capture device 14 is configured to capture a fourth image by shooting in the fourth direction D4 and output image data of the fourth image to the input unit 101.

The third image capture device 13 is configured to shoot in a third direction D3. The third image capture device 13 is configured to capture a third image by shooting in the third direction D3 and output image data of the third image to the input unit 101. Since the third image capture device 13 is configured to shoot in the third direction D3, the image of an object located at a blind spot for the first image capture device 11 and the fourth image capture device 14 behind the mobile object 20 can be captured. The third direction D3 is the direction in which the optical axis of the third image capture device 13 is oriented. The third direction D3 may coincide with the fourth direction D4. The third direction D3 and the fourth direction D4 may differ by a small amount. The small amount may be less than 10°. In the following description of the embodiment, the third direction D3 is assumed to be oriented toward the rear on the left-hand side in the same manner as, and/or similarly to, the fourth direction D4.

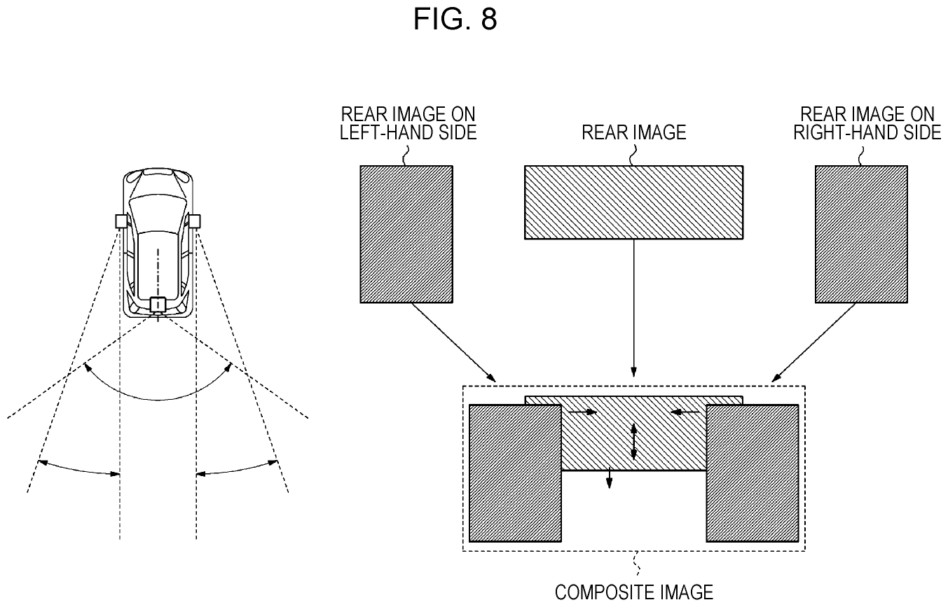

The angles of view of the first image capture device 11, the second image capture device 12, the third image capture device 13, and the fourth image capture device 14 are sufficiently smaller than the angle of view of a rearward camera in the known technology (refer to FIG. 8). For example, since a single rearward camera needs to capture an image with a wide angle of view in the known technology, the angle of view of such a camera is set to 90° or greater. In contrast, the angles of view of the first image capture device 11, the second image capture device 12, the third image capture device 13, and the fourth image capture device 14 may each be less than 90°. The angles of view of the first image capture device 11, the second image capture device 12, the third image capture device 13, and the fourth image capture device 14 may be set to values that do not differ from each other by a large amount. For example, the difference between the angles of view of the first image capture device 11 and the fourth image capture device 14 may be equal to or greater than 0° and less than 10°. For example, the difference between the angles of view of the second image capture device 12 and the third image capture device 13 may be equal to or greater than 0° and less than 10°. In addition, for example, the angles of view of the second image capture device 12 and the third image capture device 13 may each be set not to exceed the angles of view of the first image capture device 11 and the fourth image capture device 14. Although a load of image processing is large to remove awkwardness that appears at borders when combining images in the known technology, this problem can be eliminated because the angles of view of the cameras do not differ from each other by a large amount.

The first image capture device 11, the second image capture device 12, the third image capture device 13, and the fourth image capture device 14 may be disposed at the same and/or similar height in the mobile object 20. This arrangement allows the heights of the centers of captured images to be equal or nearly equal to each other, and the load of image processing for combining images can further be reduced.

In another example of the configuration, the first image capture device 11, the second image capture device 12, the third image capture device 13, and the fourth image capture device 14 may each be disposed at a position symmetrical about the center line parallel to the direction of travel of the mobile object 20. That is, the image capture system 1 may have a configuration in which the positions of the first image capture device 11 and the fourth image capture device 14 in FIG. 2 are exchanged and the positions of the second image capture device 12 and the third image capture device 13 are exchanged. In such a different configuration, the first direction D1 and the second direction D2 may be oriented toward the rear on the left-hand side, and the third direction D3 and the fourth direction D4 may be oriented toward the rear on the right-hand side. The number of cameras is not limited to four as in the present example in which the first image capture device 11, the second image capture device 12, the third image capture device 13, and the fourth image capture device 14 are disposed.

### (Display Device)

The display device 15 may provide any type of display screen. Examples of the display screen in the display device 15 include a liquid crystal display (LCD), an organic EL (electro-luminescence) display, a plasma display panel (PDP), and a field emission display (FED). The display device 15 may provide, for example, an HUD (head-up display). The display device 15 may share a display screen with an apparatus other than the image processing apparatus 10. Examples of such an apparatus other than the image processing apparatus 10 include a navigation system.

In the present embodiment, the display device 15 is used as an electronic mirror system configured to display a scene behind the mobile object 20. In the present embodiment, the display device 15 includes a first display 15A, a second display 15B, and a third display 15C. The first display 15A, the second display 15B, and the third display 15C may be provided as individual display screens or three sections into which a single display screen is partitioned.

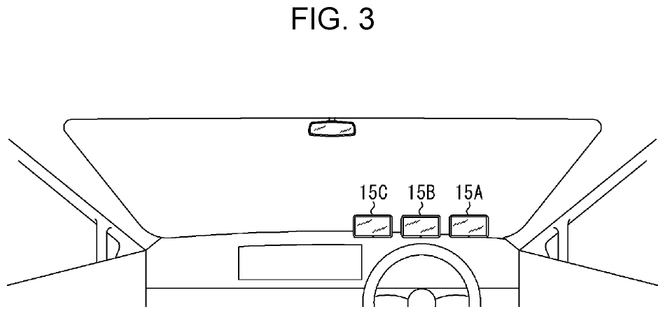

FIG. 3 depicts an example of a configuration of the display device 15 in the present embodiment. The second display 15B is provided as an individual display screen disposed in front of the steering wheel. The first display 15A and the third display 15C are each provided as an individual display screen and are disposed on the right-hand side and the left-hand side, respectively, of the second display 15B. The first display 15A is configured to display an image in the rear on the right-hand side of the mobile object 20 among the images of the surroundings of the mobile object 20. The third display 15C is configured to display an image in the rear on the left-hand side of the mobile object 20 among the images of the surroundings of the mobile object 20. The second display 15B may display, for example, a map image provided by a navigation device during a normal run of the mobile object 20. When the direction of movement of the mobile object 20 is rearward, the second display 15B may display an image of a scene behind the mobile object 20. For example, when a driver parks the mobile object 20, the second display 15B may display an image of the scene behind the mobile object 20. Such image display by the three individual display screens enables the driver to use the electronic mirror system with the feel resembling looking at conventional side view and rear view mirrors. Since image display by the three individual display screens can provide a larger image of an object located around the mobile object 20 than image display by a single display screen, the driver's visibility can be enhanced. In contrast to the image display by a single display screen, the image display by the three individual display screens allows the driver to drive without receiving unnecessary information, and thus the driver's visibility can be enhanced. For example, when a single display screen displays a scene behind the mobile object 20, information regarding a scene on the left-hand side behind the mobile object 20 is unnecessary information for a driver who wants to check information regarding a scene on the right-hand side behind the mobile object 20.

### (Image Processing Apparatus)

The image processing apparatus 10 includes the input unit 101, a controller 102, a storage 103, and an output unit 104.

The input unit 101 is configured to acquire the first image, the second image, the third image, and the fourth image, respectively, from the first image capture device 11, the second image capture device 12, the third image capture device 13, and the fourth image capture device 14. The input unit 101 is an input interface configured to receive an input of image data to the image processing apparatus 10. The input unit 101 may include a wireless or wireline communication module. The input unit 101 is configured to output received image data to the controller 102. The input unit 101 may selectively output image data required by the controller 102.

The controller 102 is configured to not only control the entire image processing apparatus 10 but also apply image processing to the first image, the second image, the third image, and the fourth image acquired by the input unit 101. The controller 102 includes one or more processors. Examples of the one or more processors include a general-purpose processor configured to load a specific program and execute a specific function and a dedicated processor configured to perform specific processing. Examples of the dedicated processor include an application specific integrated circuit (ASIC). Examples of the one or more processors include a programmable logic device (PLD). Examples of a PLD include an FPGA (field-programmable gate array). The controller 102 may be one of a SoC (system-on-a-chip) and a SiP (system in a package), in which one or more processors are configured to cooperate.

The controller 102 is configured to acquire data indicating a running state of the mobile object 20, and the data is to be used for image processing. The controller 102 may be configured to acquire such data via a network in the mobile object 20 such as a CAN (control area network).

The storage 103 is configured to store programs and various kinds of data. The programs are used to cause the controller 102 to perform image processing and control, and the data is used for the image processing and control. The storage 103 includes, for example, one or more of a semiconductor memory, a magnetic memory, and an optical memory. The image processing performed by the controller 102 includes a process for generating an image of the surroundings of the mobile object 20 by selectively joining the first image, the second image, the third image, and the fourth image, which are acquired by the input unit 101. The process for generating an image of the surroundings of the mobile object 20 will be described below as a first control, a second control, and a third control. Images to be used for generation may be selected based on the running state of the mobile object 20.

The output unit 104 is an output interface configured to output a generated image of the surroundings of the mobile object 20 to the display device 15. The output unit 104 may include a wireless or wireline communication module. Image data from the output unit 104 may be output to the display device 15, for example, via the CAN. (First Control)

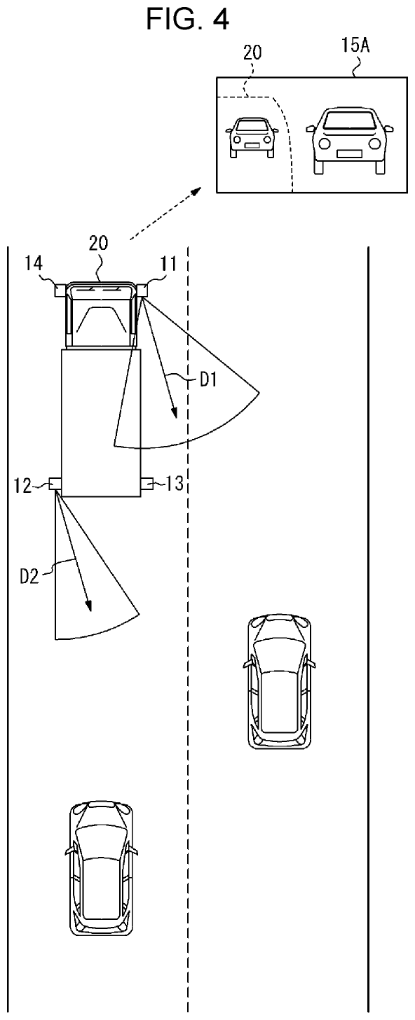

FIG. 4 describes generation of an image of the surroundings of the mobile object 20 in accordance with the first control. While the mobile object 20 travels at a high velocity, the controller 102 may perform the first control to generate an image of the surroundings of the mobile object 20 based on the first image and the second image. The image of the surroundings is acquired by combining the first image and the second image. The first image capture device 11 is configured to capture the first image by shooting in the first direction D1. The second image capture device 12 is configured to capture the second image by shooting in the second direction D2. The difference between the angles of view of the first image capture device 11 and the second image capture device 12 may be equal to or greater than 0° and less than 10°. The angle of view of the first image capture device 11 may coincide with the angle of view of the second image capture device 12. The controller 102 can generate the image of the surroundings with a small amount of processing. The image processing for combining the first image and the second image may be performed using a known method. For example, one image may be enlarged or reduced around the center and combined with the other image on the right side or the left side of the other image in the image processing. The controller 102 may similarly perform the first control to generate an image of the surroundings of the mobile object 20 based on the third image and the fourth image.

In the example in FIG. 4, since the generated image of the surroundings represents a scene on the right-hand side behind the mobile object 20, the first display 15A displays the image. In another example, if the image represents a scene on the left-hand side behind the mobile object 20, the third display 15C displays the image. In the example in FIG. 4, since the second image captures a blind spot in the first image, the driver can receive information regarding the surroundings with a reduced blind spot. The blind spot in the first image is, for example, a region obscured by the mobile object 20. As depicted in FIG. 4, the controller 102 may generate a composite image indicating an outline of the mobile object 20 in the first image. The controller 102 may generate a composite image including a transparent image of the mobile object 20 captured in the first image. The driver can easily grasp the distances to objects in the surroundings since the image including the position of the body of the mobile object 20 is displayed. The first image and the second image capture images in the first direction D1 and the second direction D2, respectively. Although the entire angle of view of the image combing these images is not wide, the composite image can include, for example, a trailing vehicle far behind. Accordingly, the composite image based on the first image and the second image is suitable for high-speed running such as a case where the mobile object 20 travels on a highway.

The controller 102 may acquire information regarding the velocity of the mobile object 20 running forward in the direction of travel and perform the first control when the velocity of the mobile object 20 exceeds a first threshold. The first threshold may be, for example, 80 km/hour. The controller 102 may acquire the information regarding the velocity, for example, from an ECU (electronic control unit) via the CAN. The ECU is an electronic control apparatus configured to control running of the mobile object 20. (Second Control)

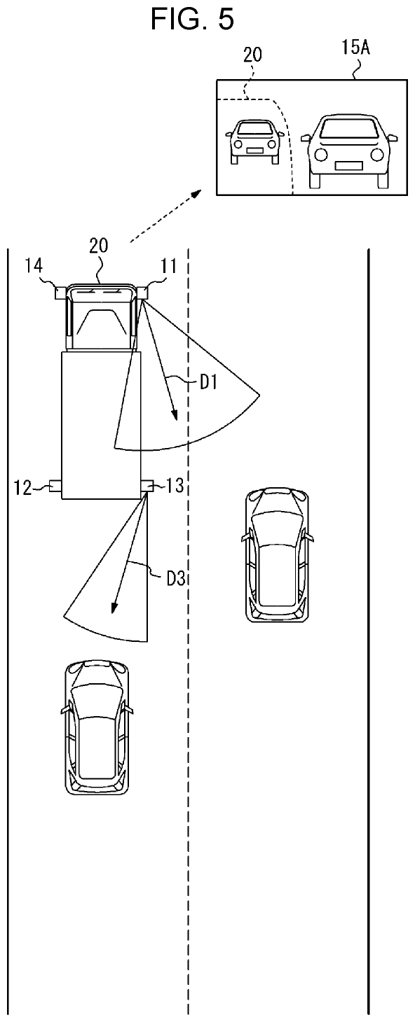

FIG. 5 describes generation of an image of the surroundings of the mobile object 20 in accordance with the second control. While the mobile object 20 travels, for example, on a city street, the controller 102 may perform the second control to generate an image of the surroundings of the mobile object 20 based on the first image and the third image. The image of the surroundings is acquired by combining the first image and the third image. The first image capture device 11 is configured to capture the first image by shooting in the first direction D1. The third image capture device 13 is configured to capture the third image by shooting in the third direction D3. Although the amount of processing is greater than the amount of processing in the first control, the controller 102 can generate the image of the surroundings with a smaller amount of processing than in the known technology. The image processing for combining the first image and the third image may be performed using a known method. For example, one image may be enlarged or reduced around the center to change viewpoints to the first direction D1 or to the third direction D3, and the image may be combined with the other image on the right side or the left side of the other image in the image processing. The controller 102 may similarly perform the second control to generate an image of the surroundings of the mobile object 20 based on the second image and the fourth image.

In the example in FIG. 5, since the generated image of the surroundings represents a scene on the right-hand side behind the mobile object 20, the first display 15A displays the image. In the example in FIG. 5, since the third image captures a blind spot in the first image, the driver can receive information regarding the surroundings with a reduced blind spot. As depicted in FIG. 5, the controller 102 may generate a composite image indicating an outline of the mobile object 20 in the first image. The controller 102 may generate a composite image including a transparent image of the mobile object 20 captured in the first image. The driver can easily grasp the distances to objects in the surroundings since the image including the position of the body of the mobile object 20 is displayed. Since the first image and the third image are obtained by shooting in the first direction D1 and the third direction D3, respectively, the entire angle of view of the image combing these images becomes wide, and an object approaching the vicinity of the rear of the mobile object 20 can be included without fail. Accordingly, the composite image based on the first image and the third image is suitable for the mobile object 20 traveling, for example, on a city street.

The controller 102 may acquire information regarding the velocity of the mobile object 20 running forward in the direction of travel and perform the second control when the velocity of the mobile object 20 is equal to or less than the first threshold.

### (Third Control)

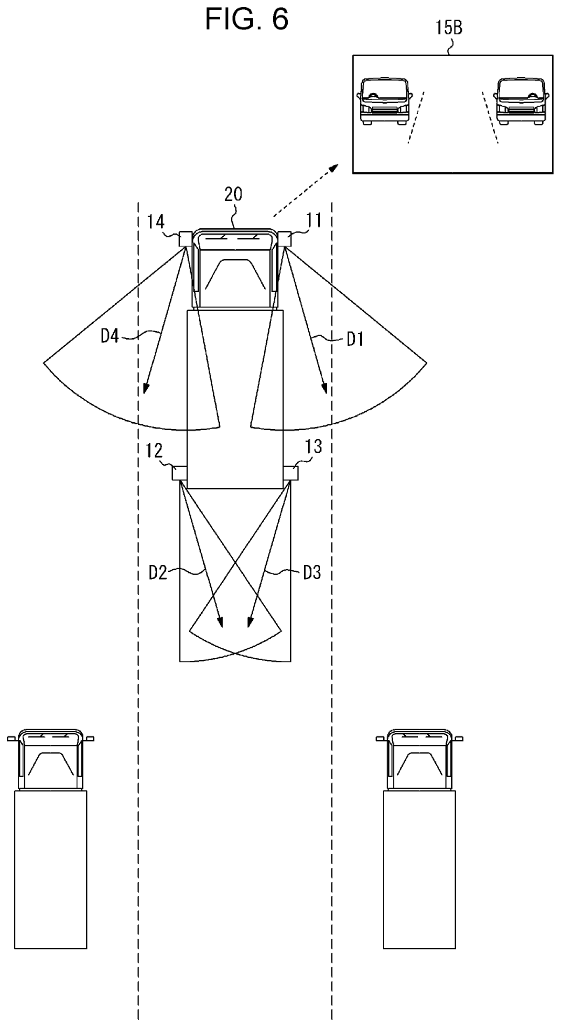

FIG. 6 describes generation of an image of the surroundings of the mobile object 20 in accordance with the third control. For example, while the mobile object 20 is being parked, the controller 102 performs the third control to generate an image of the surroundings of the mobile object 20 based on the second image and the third image. The image of the surroundings is acquired by combining the second image and the third image. The image processing for combining the second image and the third image may be performed using a known method. For example, using a composite processing method based on a stereo camera, a stereoscopic rear view image may be generated as the image of the surroundings.

In the example in FIG. 6, since the generated image of the surroundings represents a scene viewed straight ahead rearward from the mobile object 20, the second display 15B may display the image. As in the example in FIG. 6, the generated image also displays a part obscured by the mobile object 20, and the driver can receive information regarding the surroundings with a reduced blind spot. Since the second image capture device 12 captures the second image by shooting in the second direction D2 and the third image capture device 13 captures the third image by shooting in the third direction D3, the entire angle of view of the image combing these images becomes wide, and an object behind the mobile object 20 can be displayed in the image. The composite image based on the second image and the third image is suitable for parking the mobile object 20. To further increase the entire angle of view of the composite image, the controller 102 may perform the third control further based on the first image and the fourth image. That is, the controller 102 may perform the third control to generate an image of the surroundings of the mobile object 20 by using the first image, the second image, the third image, and the fourth image.

The controller 102 may acquire information regarding the velocity and the direction of movement of the mobile object 20 and perform the third control when the velocity of the mobile object 20 is equal to or less than the second threshold and the direction of movement of the mobile object 20 is rearward. The second threshold may be, for example, 20 km/hour. The controller 102 may acquire the information regarding the direction of movement, for example, from the ECU via the CAN as the information regarding the velocity is acquired.

### (Method for Image Processing)

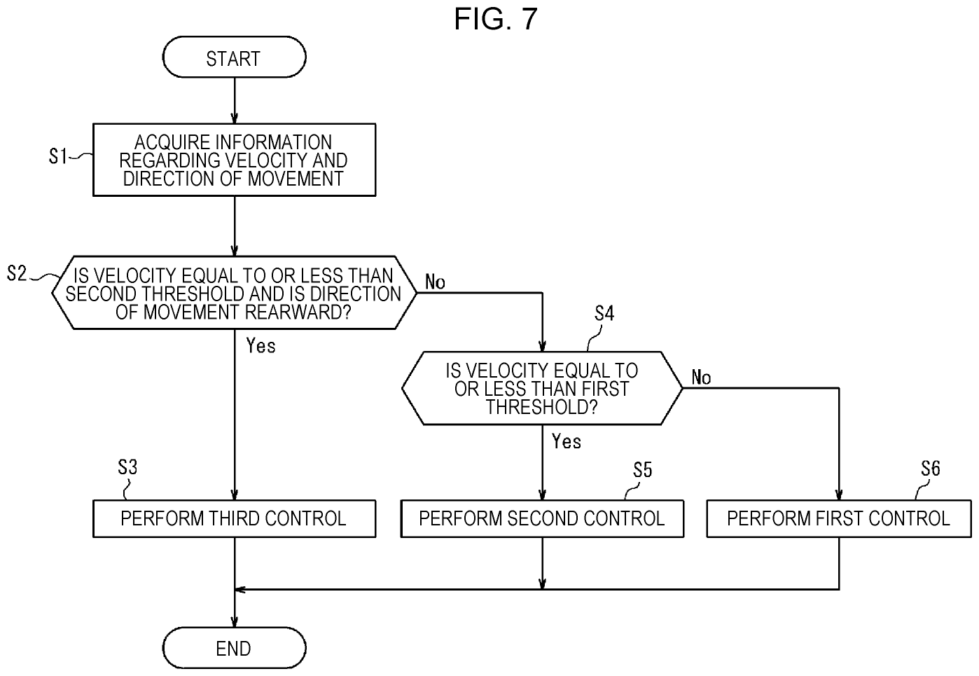

Referring to FIG. 7, a method for image processing performed by the controller 102 will be described below. The controller 102 is configured to perform a process of a flowchart depicted in FIG. 7 in accordance with a program stored in the storage 103. The program may be implemented by loading the program recorded in a non-transitory computer-readable medium. Examples of the non-transitory computer-readable medium include, but are not limited to, a magnetic recording medium, an optical recording medium, a magneto-optic recording medium, and a semiconductor recording medium.

First, the controller 102 acquires information regarding the velocity and the direction of movement of the mobile object 20, for example, from the ECU (step S1).

If the velocity of the mobile object 20 is equal to or less than the second threshold and the direction of movement is rearward (Yes in step S2), the controller 102 performs the third control (step S3). If the velocity of the mobile object 20 is neither equal to nor less than the second threshold or the direction of movement is not rearward (No in step S2), the controller 102 performs a process in step S4.

If the velocity of the mobile object 20 is equal to or less than the first threshold (Yes in step S4), the controller 102 performs the second control (step S5).

If the velocity of the mobile object 20 exceeds the first threshold (No in step S4), the controller 102 performs the first control (step S6).

As described above, in the present embodiment, the image processing apparatus 10 and the mobile object 20 including the image processing apparatus 10 are able to generate an image of the surroundings of the mobile object 20 with the above configuration without increasing a processing load.

The embodiment according to the present disclosure has been described with reference to the drawings and based on the example. Note that those skilled in the art easily perform various variations or corrections based on the present disclosure. Thus, note that those variations or corrections are within the scope of the present disclosure. For example, each constituent or a function included in each step or the like may be rearranged in a logically compatible manner, and combining multiple constituents, steps, or the like into one or dividing a constituent, a step, or the like is possible. The embodiment according to the present disclosure may also be implemented as a program to be executed by a processor included in an apparatus or as a recording medium storing such a program. It should be appreciated that such a program and such a recording medium are also within the scope of the present disclosure.

In the present disclosure, examples of the “mobile object” include a vehicle, a vessel, and an aircraft. In the present disclosure, examples of a “vehicle” include, but are not limited to, an automobile and an industrial vehicle and may include a rail car, a resident car, and a fixed-wing aircraft that taxies along a runway. Examples of an automobile include, but are not limited to, a truck, a passenger car, a bus, a motorcycle, and a trolleybus and may include other vehicles that run on a road. Examples of an industrial vehicle include industrial vehicles for agriculture and for construction. Examples of an industrial vehicle include, but are not limited to, a forklift truck and a golf cart. Examples of an industrial vehicle for agriculture include, but are not limited to, a tractor, a cultivator, a transplanting machine, a binder, a combine, and a lawnmower. Examples of an industrial vehicle for construction include, but are not limited to, a bulldozer, a scraper, an excavator, a crane truck, a dump truck, and a road roller. Examples of a vehicle include a human-powered vehicle. Categories of vehicles are not limited to the examples described above. For example, examples of an automobile may include an industrial vehicle that can run on a road, and one vehicle may be included in multiple categories. In the present disclosure, examples of a vessel include a marine jet, a boat, and a tanker. In the present disclosure, examples of an aircraft include a fixed-wing aircraft and a rotary-wing aircraft.

### REFERENCE SIGNS

1 image capture system
10 image processing apparatus
11 first image capture device
12 second image capture device
13 third image capture device
14 fourth image capture device
15 display device
15A first display
15B second display
15C third display
20 mobile object
101 input unit
102 controller
103 storage
104 output unit
D1 first direction
D2 second direction
D3 third direction
D4 fourth direction

1. An image processing apparatus comprising:
an input unit configured to acquire a first image and a second image, the first image being captured by a first image capture device configured to shoot in a first direction toward rear on a right-hand side relative to a direction of travel of a mobile object, the second image being captured by a second image capture device, the second image capture device being disposed away from the first image capture device in the direction of travel and in a left or right direction and being configured to shoot in a second direction toward the rear on the right-hand side; and
a controller configured to perform a first control to generate an image of surroundings of the mobile object based on the first image and the second image.

2. The image processing apparatus according to claim 1,
wherein the input unit is configured to acquire a third image captured by a third image capture device, the third image capture device being disposed away from the first image capture device in the direction of travel and being configured to shoot in a third direction toward the rear on a left-hand side, and
the controller is configured to perform a second control to generate an image of the surroundings of the mobile object based on the first image and the third image.

3. The image processing apparatus according to claim 2,
wherein the controller is configured to acquire information regarding a velocity of the mobile object and perform the second control when the velocity of the mobile object is equal to or less than a first threshold.

4. The image processing apparatus according to claim 1,
wherein the input unit is configured to acquire a third image captured by a third image capture device, the third image capture device being disposed away from the first image capture device in the direction of travel and being configured to shoot in a third direction toward the rear on a left-hand side, and
the controller is configured to perform a third control to generate an image of the surroundings of the mobile object based on the second image and the third image.

5. The image processing apparatus according to claim 4,
wherein the controller is configured to acquire information regarding a velocity and a direction of movement of the mobile object and perform the third control when the velocity of the mobile object is equal to or less than a second threshold and the direction of movement of the mobile object is rearward.

6. The image processing apparatus according to claim 4 or 5,
wherein the input unit is configured to acquire a fourth image captured by a fourth image capture device, the fourth image capture device being disposed away from the first image capture device in the left or right direction and being configured to shoot in a fourth direction toward the rear on the left-hand side, and
the controller is configured to perform the third control further based on the first image and the fourth image.

7. The image processing apparatus according to claim 6,
wherein the second image capture device is disposed away from the first image capture device in a rear direction and in a left direction relative to the direction of travel,
the third image capture device is disposed away from the first image capture device in the rear direction relative to the direction of travel and is disposed away from the second image capture device in a right direction relative to the direction of travel, and the fourth image capture device is disposed away from the first image capture device in the left direction relative to the direction of travel and is disposed away from the second image capture device in a front direction relative to the direction of travel.

8. The image processing apparatus according to claim 1,
wherein a difference between angles of view of the first image capture device and the second image capture device is equal to or greater than 0° and is less than 10°.

9. The image processing apparatus according to claim 1,
wherein an angle of view of the first image capture device coincides with an angle of view of the second image capture device.

10. The image processing apparatus according to claim 6,
wherein the first image capture device, the second image capture device, the third image capture device, and the fourth image capture device are disposed at a same and/or similar height in the mobile object.

11. A mobile object comprising:
an image processing apparatus comprising:
an input unit configured to acquire a first image and a second image, the first image being captured by a first image capture device configured to shoot in a first direction toward rear on a right-hand side relative to a direction of travel of the mobile object, the second image being captured by a second image capture device, the second image capture device being disposed away from the first image capture device in the direction of travel and in a left or right direction and being configured to shoot in a second direction toward the rear on the right-hand side; and
a controller configured to perform a first control to generate an image of surroundings of the mobile object based on the first image and the second image.

12. A non-transitory computer-readable recording medium including computer program instructions configured to cause a controller in an image processing apparatus to:
perform a first control to generate an image of surroundings of a mobile object based on a first image and a second image,
wherein the image processing apparatus comprises an input unit and the controller, the input unit being configured to acquire the first image and the second image, the first image being captured by a first image capture device configured to shoot in a first direction toward rear on a right-hand side relative to a direction of travel of the mobile object, the second image being captured by a second image capture device, the second image capture device being disposed away from the first image capture device in the direction of travel and in a left or right direction and being configured to shoot in a second direction toward the rear on the right-hand side.

13-15. (canceled)
